(19) United States
(12) Patent Application Publication
(10) Pub. No.: US 2026/0342937 A1
(43) Pub. Date: Oct. 29, 2026

(54) Image Processing Method and Video Processor Thereof

(71) Applicant: NOVATEK Microelectronics Corp., Hsinchu (TW)

(72) Inventors: Chih Chang, Hsinchu City (TW); Yi-Hung Huang, Hsinchu County (TW); Hsiao-En Chang, Hsinchu County (TW)

(73) Assignee: NOVATEK Microelectronics Corp., Hsinchu (TW)

(21) Appl. No.: 19/735,477

(22) Filed: Jul. 8, 2026

Related U.S. Application Data
(63) Continuation-in-part of application No. 19/358,456, filed on Oct. 15, 2025.

(30) Foreign Application Priority Data
Oct. 16, 2024 (TW) 113139243
Sep. 3, 2025 (TW) 114133675

(51) Int. Cl. H04N 7/01

(52) U.S. Cl. CPC H04N 7/0127; H04N 7/014

(57) ABSTRACT

An image processing method for a video processor includes receiving at a first input frame a first time instant and receiving a second input frame at a second time instant. When the second input frame is not a first next scheduled frame corresponding to the first input frame, according to the first and second input frames, a first inserted frame is generated using interpolation. When no input frame is received at a third time instant, according to the first and second input frames, a second inserted frame is generated using extrapolation. A time difference between the third and second time instants is substantially greater than or equal to a time difference threshold. The video playback smoothness can be improved by dynamically switching between extrapolation and interpolation.

### CROSS REFERENCE TO RELATED APPLICATIONS

This application is a continuation-in-part of U.S. application Ser. No. 19/358,456, filed on Oct. 15, 2025. The content of the application is incorporated herein by reference.

### BACKGROUND OF THE INVENTION

### 1. Field of the Invention

The present invention relates to a method for performing motion estimation and motion compensation, and more particularly, to a method for solving unstable input images using motion estimation and motion compensation.

### 2. Description of the Prior Art

In image processing technology, motion estimation and motion compensation (MEMC) is a technology using frame interpolation/extrapolation. This technology identifies a motion vector (MV) of a moving object between two consecutive image frames and inserts an inserted frame between them, thereby enabling a series of image frames to be displayed at a higher frame rate. However, when input images are unstable, the existing methods fail to output images smoothly.

### SUMMARY OF THE INVENTION

An embodiment of the present application discloses an image processing method, for a video processor, comprising receiving a first input frame at a first time instant; and receiving a second input frame at a second time instant; wherein when the second input frame is not a first next scheduled frame corresponding to the first input frame, a first inserted frame is generated using interpolation according to the first and second input frames; or when no input frame is received at a third time instant, a second inserted frame is generated using extrapolation according to the first and second input frames, wherein a time difference between the third and second time instants is substantially greater than or equal to a time difference threshold.

An embodiment of the present application discloses a video processor, comprising a frame rate converter, configured to receive a first input frame at a first time instant, and receive a second input frame at a second time instant; and a frame buffer, configured to store the first or second input frame; wherein when the second input frame is not a first next scheduled frame corresponding to the first input frame, a first inserted frame is generated using interpolation according to the first and second input frames; or when no input frame is received at a third time instant, a second inserted frame is generated using extrapolation according to the first and second input frames, wherein a time difference between the third and second time instants is substantially greater than or equal to a time difference threshold.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of an electronic system according to an embodiment of the present disclosure.

FIG. 2 is a flowchart of an image processing method according to an embodiment of the present invention.

FIG. 3 to FIG. 8 illustrate frame rate conversion of converting a source video of 60 Hz into 120 Hz for display according to embodiments of the present disclosure.

FIG. 9 is a flowchart of an image processing method according to an embodiment of the present invention.

### DETAILED DESCRIPTION

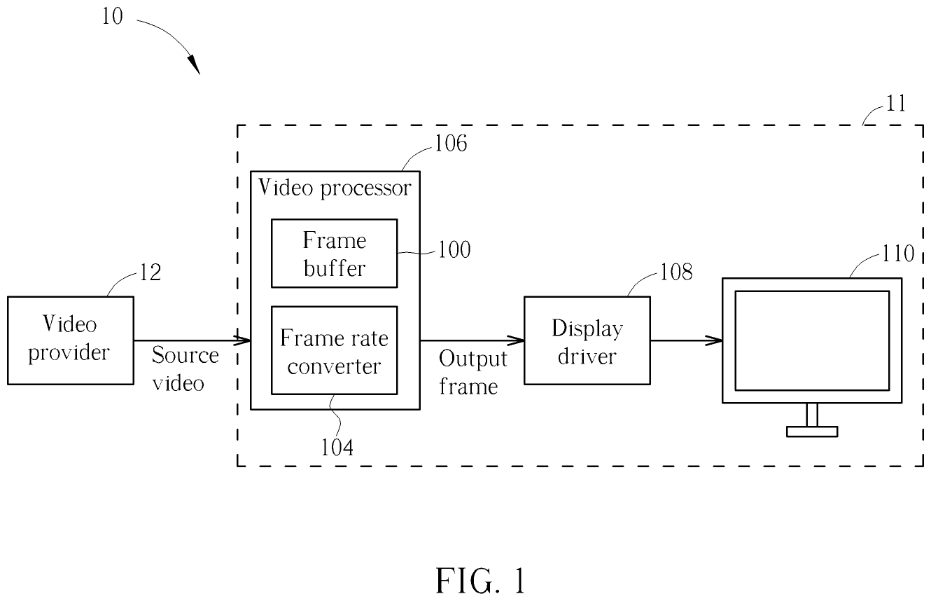

FIG. 1 is a schematic diagram of an electronic system 10 according to an embodiment of the present disclosure. In the electronic system 10, a display system 11 may receive and display a source video. The source video, which comprises a series of image frames, may be provided by a video provider 12 (e.g., an application processor (AP) or an application program (APP)). The display system 11 comprises a video processor 106, a display driver 108, and a display panel 110.

The video processor 106 may perform frame rate conversion (FRC) to produce smoother output frames. Specifically, for reasons such as power considerations, the frame rate of the source video may differ from the frame rate intended to be displayed on the display panel 110. To address this, a frame rate converter 104 of the video processor 106 may convert the source video with a lower frame rate, and generate a series of output frames with a higher frame rate. In this manner, the display panel 110 may render video corresponding to the higher frame rate.

For example, when the frame rate of an input image is 30 Hertz (Hz), the frame rate converter 104 may convert two received input frames (e.g., A and B) into four output frames of 60 Hz, namely A, a first inserted frame, B, and a second inserted frame. (Here, an inserted frame refers to an interpolated/extrapolated/synthesized frame or an in-between frame.) In this manner, the frame rate converter 104 may convert input images with a frame rate of 30 Hz into output images with a frame rate of 60 Hz. In one embodiment, according to interpolation, the second inserted frame may be generated using a previously received image frame (referred to as the previous frame) and a currently received image frame (referred to as the current frame) both received by the video processor 106. Interpolation refers to calculating content between the previous frame (e.g., A) and the current frame (e.g., B) based on the two input frames (e.g., A and B). In another embodiment, according to extrapolation, the second inserted frame may be generated using the two input frames (e.g., A and B). Extrapolation refers to calculating/predicting content that is temporally ahead of the current frame based on the previous frame and the current frame. In yet another embodiment, the frame rate converter 104 may convert the received two input frames (e.g., A and B) into four output frames A, A, B, and B.

However, the video provider 12 may not be able to input a certain image frame to the video processor 106, or fail to do so in time, resulting in an irregular/non-ideal input condition (e.g., a delay or a frame drop). For example, when a mobile phone executes a game application, the front-end video provider 12 may become overloaded/overheated, causing the rendering time to exceed expectations. As a result, although the video provider 12 is expected to deliver 60 frames of images per second (i.e., the frame rate is 60 frames per second (FPS)) to the display driver 108 or video processor 106, it may only provide 55 frames of images per second in practice. This may cause incorrect image display by the display driver 108 and a degraded user experience.

To improve user experience, the frame rate converter 104 of the present disclosure steadily generates a series of output frames at a desired output frame rate, regardless of whether the input condition is ideal. Furthermore, the frame rate converter 104 may select either interpolation or extrapolation based on the input condition of image frames to compute inserted frame(s), thereby ensuring video playback smoothness and image quality. For example, when interpolation is determined to be appropriate under an input condition, interpolation is selected from interpolation and extrapolation to create consecutive output frames. Alternatively (e.g., when a delay occurs), extrapolation is temporarily selected from interpolation and extrapolation to generate output frames. When the input frame rate or the input condition of image frame(s) deviates from expectation(s), this dynamic switching eliminates visual stuttering that interpolation might cause, and also avoids poor image quality in inserted frame(s) caused by extrapolation. Moreover, the switching mechanism between interpolation and extrapolation in the present disclosure maintains display smoothness.

In one embodiment, whether interpolation or extrapolation is used may be determined based on a phase. For example, when the phase is greater than or equal to 1, extrapolation is used; when the phase is less than 1, interpolation is used. The phase may be regarded as a weight used by Motion Estimation and Motion Compensation (MEMC) to generate an inserted frame. For example, any given input frame may comprise at least one image block, and any image block of an inserted frame may be generated using a phase and based on an image block of the current frame and a corresponding image block of the previous frame. The image block of the current frame, the corresponding image block of the previous frame, and the corresponding image block of the inserted frame may correspond to the same object (e.g., a soccer ball image or a virtual object). As another example, the difference between the position (or virtual position) of the image block of the current frame and the position (or virtual position) of the corresponding image block of the previous frame may form a motion vector (MV), and the position of the corresponding image block in the inserted frame may be inferred based on the motion vector and the phase. For instance, any image block of the inserted frame may satisfy x=a+(b−a)×p, where a, b, and x represent the coordinates (or virtual positions) of the image block in the previous frame A, the current frame B, and the inserted frame x, respectively, b−a represents the motion vector; and p represents the phase, which may be a non-negative real number. As the phase p increases from 0 to a value greater than 1, x transitions from within an interpolation interval [a, b] to outside the interpolation interval [a, b], and the insertion scheme switches from interpolation to extrapolation.

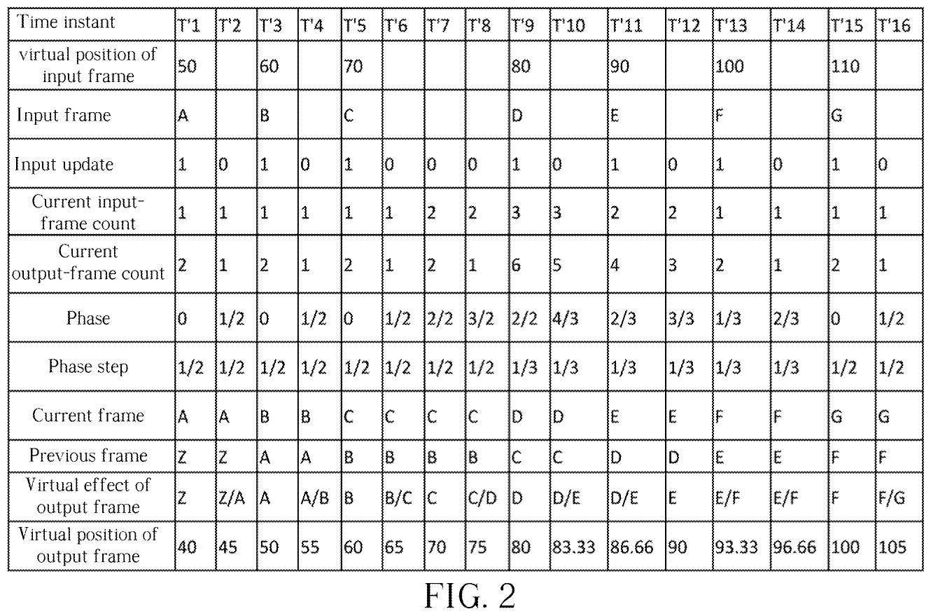

In one embodiment, the frame rate converter 104 may dynamically adjust a phase step or phase based on an input condition, thereby switching between extrapolation and interpolation. In another embodiment (e.g., FIG. 2), the phase (e.g., ½) corresponding to a time instant (e.g., T′2) may be a function of the phase step (e.g., ½) and phase (e.g., 0) corresponding to the previous time instant (e.g., T′1). Accordingly, the frame rate converter 104 may dynamically adjust the phase step based on the input condition, thereby modifying the phase and switching between extrapolation and interpolation.

An image processing method according to an embodiment of the present disclosure may explain how the phase step or phase is dynamically adjusted. The image processing method, which may be implemented by a video processor (e.g., 106) or a frame rate converter (e.g., 104), may comprise the following steps:

Step S201: Within a predetermined time period (e.g., a time duration comprising a time instant T′″17), detect whether an input frame is received, and access/utilize stored parameters. Then, proceed to Step S202.

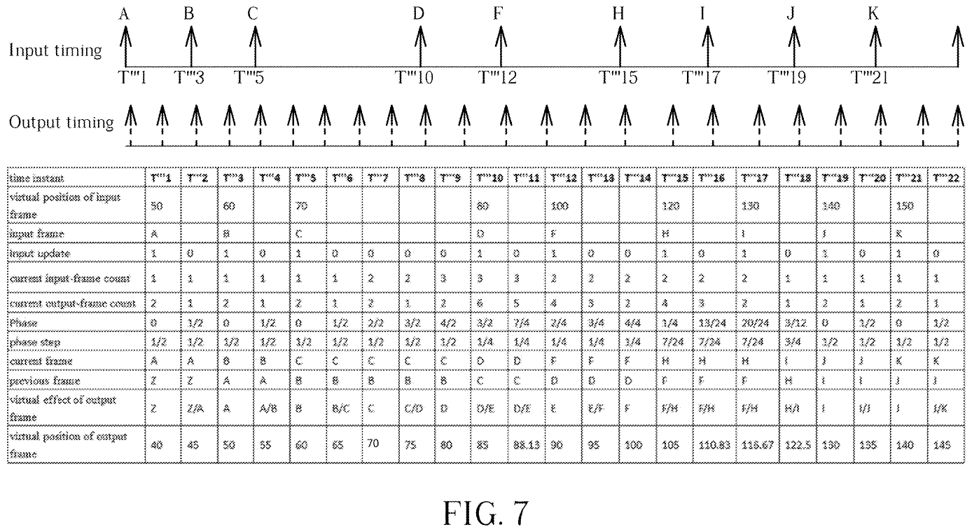

In one embodiment (e.g., FIG. 7), the frame rate converter 104 may receive an input frame (e.g., I) at a time instant (e.g., T′″17).

In one embodiment, the frame rate converter 104 may read the phase or phase step corresponding to a previous time instant (e.g., T′″17). Alternatively, the frame rate converter 104 may determine whether the sum of the phase corresponding to the previous time instant (e.g., T′″17) and the phase step corresponding to the previous time instant is less than 1.

Step S202: Calculate the phase corresponding to the time instant. The calculation of the phase may be adjusted when an input frame movement offset (e.g., a frame drop) occurs, or when the input frame movement offset no longer persists (e.g., recovering from a frame drop to a non-frame-drop state). Then, proceed to Step S203.

In other words, the calculation of the phase may be adjusted according to the input condition. In one embodiment (e.g., FIG. 7), when the input frame (e.g., F) is not the next scheduled frame (e.g., E) corresponding to the previous input frame (e.g., D), or when the input frame (e.g., I) returns to the next scheduled frame (also referred to as an expected subsequent frame) corresponding to the previous input frame (e.g., H), the phase corresponding to the time instant (e.g., T′″12 or T′″18) is at least a function of a scaling value corresponding to the time instant, the phase corresponding to the previous time instant, or the phase step corresponding to the previous time instant. The scaling value is described in further detail below. In one embodiment (e.g., FIG. 7), when at least one of the following happens—the phase at the previous time instant (e.g., T′″16) plus the phase step corresponding to the previous time instant is less than 1, no frame drop occurs, or the state is not recovering from a frame drop to a non-frame-drop state—the phase corresponding to the time instant (T′″17, T′″10, T′″11, or T′″15) is at least a function of the phase corresponding to the previous time instant or the phase step corresponding to the previous time instant.

Step S203: Determine whether to recalculate the phase step corresponding to the time instant for use at the next time instant. The recalculation of the phase step corresponding to the time instant is determined to be necessary when at least one of the following happens—an irregular/non-ideal input condition (e.g., a delay or a frame drop) occurs, the irregular/non-ideal input condition no longer persists (e.g., recovering from a frame drop to a non-frame-drop state), or an input-output cycle restarts. Then, proceed to Step S204.

The calculation of the phase step may be adjusted according to the input condition. In one embodiment (e.g., FIG. 7), when the input frame (e.g., F) is not the next scheduled frame (e.g., E) corresponding to the previous input frame (e.g., D), or when the input frame (e.g., I) returns to the next scheduled frame corresponding to the previous input frame (e.g., H), the phase step corresponding to the time instant (e.g., T′″12 or T′″18) is at least a function of the phase corresponding to the time instant or an order index. An order index indicates the default sequential order (e.g., the second or the first) in which the input frame (e.g., F or I) is scheduled after the previous input frame (e.g., D or H). In one embodiment (e.g., FIG. 7), when the time difference between the reception time instants (e.g., T′″5 and T′″10) of the two most recently received input frames is greater than the reciprocal (e.g., 1/60 second) of a predetermined input frame rate (e.g., 60 Hz), the phase step corresponding to the time instant (e.g., T′″10) is at least a function of the phase corresponding to the time instant, the ratio between the input frame rate and the output frame rate, or the number of inserted frames corresponding to the time difference. In one embodiment (e.g., FIG. 7), when an input-output cycle restarts, the phase step corresponding to the time instant (e.g., T′″3 or T′″19) is at least a function of the ratio between the input frame rate and the output frame rate.

Step S204: Obtain a previous frame and a current frame corresponding to the time instant. Then, proceed to Step S205.

In one embodiment (e.g., FIG. 7), the frame rate converter 104 may receive input frames (e.g., A and B) at the previous time instant (e.g., T′″1) and the time instant (e.g., T′″3), respectively, utilizing them as the previous frame and the current frame corresponding to the time instant, respectively. In another embodiment (e.g., FIG. 7), the frame rate converter 104 may receive an input frame (e.g., I) at the time instant (e.g., T′″17), yet utilize two previously received input frames (e.g., F and H) as the previous frame and the current frame corresponding to the time instant, respectively. In yet another embodiment (e.g., FIG. 7), the frame rate converter 104 may not receive any input frame at the time instant (e.g., T′″7), and the frame rate converter 104 may use two previously received input frames (e.g., B and C) as the previous frame and the current frame corresponding to the time instant, respectively.

Step S205: Based on the previous frame and the current frame corresponding to the time instant, perform motion estimation and motion compensation using the phase corresponding to the time instant to generate an inserted frame. Determine whether to repeat Step S201.

In the image processing method of the present disclosure, when input is delayed, the phase step may be fine-tuned according to the input condition. When it is determined that an input frame image has offset (e.g., the image displacement intervals are non-uniform/non-equidistant), the phase value and phase step may be adjusted. If an input frame delay or an input frame movement offset occurs again, the adjustments are repeated to dynamically switch between extrapolation and interpolation, thereby ensuring that the calculated inserted frames remain continuous and smooth without stuttering.

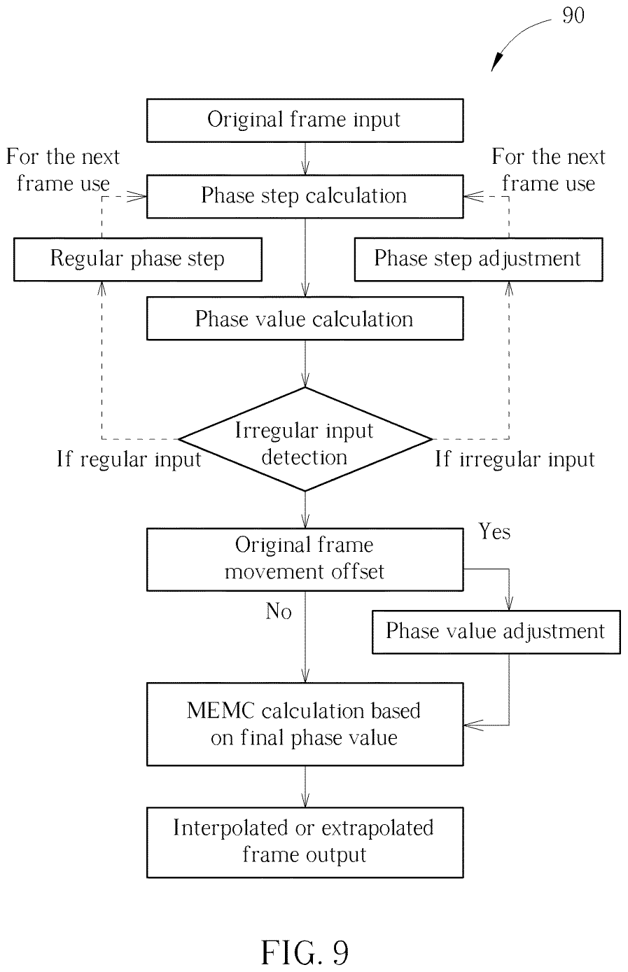

Steps S201 to S205 may be embodied as an image processing method 90 shown in FIG. 9.

FIG. 2 illustrates frame rate conversion of converting a source video of 60 Hz into 120 Hz for display according to an embodiment of the present disclosure.

Corresponding to time instants T′3 and T′4 in FIG. 2, the video processor 106 receives one input frame B and outputs two output frames according to an ideal/regular pattern. The video processor 106 may combine a previous frame A and the current frame B based at least on a phase, and generate inserted frames corresponding to the time instants T′3 and T′4 using interpolation. For the time instant T′3, since the video processor 106 receives the input frame B, the video processor 106 may, in Step S202, calculate the phase corresponding to the time instant T′3 by adding the phase corresponding to the time instant T′2 to the phase step corresponding to the time instant T′2, and subtracting 1. Consequently, the phase corresponding to the time instant T′3 is equal to 0 (i.e., ½+½−1). For the time instant T′4, since the video processor 106 does not receive any input frame, the video processor 106 may, in Step S202, set the phase corresponding to the time instant T′4 to be the phase corresponding to the time instant T′3 plus the phase step corresponding to the time instant T′3. Accordingly, the phase corresponding to the time instant T′4 is ½ (i.e., 0+½). As set forth above, when the reception of input frames follows the ideal/regular pattern, the phase may alternate regularly and cycle as 0, ½, 0, ½.

When the video processor 106 receives the input frame B at the time instant T′3, the video processor 106, in Step S203, determines that no irregular/non-ideal input condition has occurred, or determines that an input-output cycle has restarted. Accordingly, the video processor 106 may either continue to use the initial phase step (e.g., ½) without recalculation, or recalculate the phase step to match the initial phase step. For example, the video processor 106 may preset the initial phase step as the current input-frame count divided by the current output-frame count upon power-on of the video processor 106, or when the video processor 106 receives (e.g., one) input frame(s) and outputs (e.g., two) output frame(s) in conformance with the ideal/regular pattern (e.g., at time instant T′1). The current input-frame count reflects the instantaneous change in the number of input frames within one input-output cycle; the current output-frame count reflects the instantaneous changes in the number of output frames within one input-output cycle. The video processor 106 may preset the current input-frame count and the current output-frame count to conform to the ratio between the input frame rate and the output frame rate. Accordingly, the phase step is preset to conform to the ratio between the input frame rate and the output frame rate. For example, when the input frame rate divided by the output frame rate (e.g., 60 Hz divided by 120 Hz) equals ½, the current input-frame count, the current output-frame count, and the phase step corresponding to a time instant (e.g., T′1) may be set to 1, 2, and ½, respectively. Alternatively, the current input-frame count or the current output-frame count may be set to a larger initial value, such that a change in the phase step is more gradual when an irregular/non-ideal input condition occurs. For example, the current input-frame count, the current output-frame count, and the phase step may also be set to 3, 6, and 3/6, respectively.

Corresponding to time instants T′5 and T′6 in FIG. 2, the video processor 106 receives one input frame C and outputs two output frames in conformance with the ideal/regular pattern. However, at time instant T′7, the video processor 106 does not receive any input frame, meaning that an irregular/non-ideal input condition (i.e., a delay) occurs. The video processor 106 may combine a previous frame B and a current frame C based at least on a phase, and generate inserted frames corresponding to the time instants T′5 to T′8 using interpolation or extrapolation. For the time instant T′5, since the video processor 106 receives one input frame C, the video processor 106 may, in Step S202, calculate the phase corresponding to the time instant T′5 as 0 (i.e., ½+½−1), in a manner similar to the calculation of the phase corresponding to the time instant T′3. For the time instants T′6 to T′8, since the video processor 106 does not receive any input frame, the video processor 106 may, in Step S202, set the phases corresponding to the time instants T′6 to T′8 to be the phases corresponding to the time instants T′5 to T′7 plus the phase steps corresponding to the time instants T′5 to T′7, respectively. Accordingly, the phases corresponding to the time instants T′6 to T′8 are ½, 2/2, and 3/2 (i.e., 0+½, ½+½, and 2/2+½), respectively. As set forth above, since the time difference (or the corresponding number of inserted frames) between the time instants T′5 and T′3 is determined to be twice the time difference (or the corresponding number of inserted frames) between the time instants T′3 and T′1, after the input frame C is received, the video processor 106 may generate output frames with the phases of 0 and ½, using interpolation. Subsequently, since the input frame D is determined to be delayed, the video processor 106 may switch to extrapolation to generate output frames with phases 2/2 and 3/2. In other words, after an irregular/non-ideal input condition occurs, phases gradually diverge.

Please note that, from time instants T′1 to T′8, the phase step remains at the initial value of ½. However, the irregular/non-ideal input condition occurring at time instant T′7 may affect subsequent phase calculations. Correspondingly, the video processor 106 may record the occurrence of the irregular/non-ideal input condition by calculating the current input-frame count and the current output-frame count so as to facilitate subsequent adjustments to the phase or phase step. Basically, after the video processor 106 initializes the current input-frame count and the current output-frame count, whenever the video processor 106 outputs one inserted frame, the current input-frame count remains unchanged, but the current output-frame count is decremented by 1. For example, the current output-frame count corresponding to the time instant T′2 is the current output-frame count corresponding to the time instant T′1 minus 1 (i.e., 2−1=1). Furthermore, each time the video processor 106 updates a frame set comprising the previous frame and the current frame, the video processor 106 may decrement the current input-frame count by 1. For example, the previous frame and the current frame corresponding to the time instant T′2 are Z and A, respectively; the previous frame and the current frame corresponding to the time instant T′3 are A and B, respectively. Therefore, the current input-frame count corresponding to the time instant T′3 equals the current input-frame count corresponding to the time instant T′2 minus 1 (i.e., 1−1=0). In addition, since the current input-frame count and the current output-frame count corresponding to the time instant T′3 both drop to 0—indicating that one input-output cycle ends at the time instant T′2 and a new input-output cycle restarts at the time instant T′3—the video processor 106 may reset the current input-frame count and the current output-frame count corresponding to the time instant T′3 to their initial values of 1 and 2, respectively. However, if the current input-frame count is not 0 but the current output-frame count is decremented to 0—indicating that an input frame is not received in time at the expected time instant—the video processor 106 may add compensation values (e.g., 1 and 2) to the current input-frame count and the current output-frame count according to the ratio between the input frame rate and the output frame rate. As a result, the video processor 106 may effectively record/track the number of inserted frames generated using extrapolation. For example, the video processor 106 may determine that the current output-frame count corresponding to the time instant T′6 minus 1 equals 0, and therefore calculate the current output-frame count corresponding to the time instant T′7 as 2 (i.e., 0+2), and calculate the current input-frame count corresponding to the time instant T′7 as 2 (i.e., 1+1). As set forth above, the calculation of the current input-frame count and the current output-frame count may reflect the irregular/non-ideal input condition occurring at the time instant T′7, which may play a role when adjusting the phase step in Step S203.

Corresponding to time instants T′9 and T′10 in FIG. 2, the video processor 106 receives one input frame D and outputs two output frames after the irregular/non-ideal input condition has occurred. The video processor 106 may combine a previous frame C and a current frame D based at least on a phase, and generate inserted frames corresponding to the time instants T′9 and T′10 using extrapolation. For the time instant T′9, since the video processor 106 receives the input frame D, the video processor 106 may set the phase corresponding to the time instant T′9 (i.e., 3/2+½−1=2/2) to be the phase corresponding to the time instant T′8 plus the phase step corresponding to the time instant T′8 minus 1. Because of the delay occurring at the time instant T′7, after the video processor 106 calculates the phase corresponding to the time instant T′9 in Step S202, the video processor 106 may adjust the phase step corresponding to the time instant T′9 in Step S203. Accordingly, phases after the time instant T′9 gradually converge. For the time instant T′10, since the video processor 106 does not receive any input frame, the video processor 106 may, in Step S202, set the phase corresponding to the time instant T′10 (i.e., 2/2+⅓=4/3) to be the phase corresponding to the time instant T′9 plus the phase step corresponding to the time instant T′9 (e.g., adjusted to ⅓).

The phase step may be adjusted in various ways. For example, according to Equation (1), the video processor 106 may, in Step S203, adjust the phase step corresponding to the time instant T′9 to ⅓

$$( i . e . , \frac{3 - \frac{3}{2}}{6} ) ,$$

given that the phase, the current input-frame count, and the current output-frame count corresponding to the time instant T′9 are 2/2, 3, and 6, respectively. Accordingly, the adjusted phase step corresponding to the time instant T′9 differs from or is less than the phase step corresponding to the time instant T′8 (i.e., ½). Specifically, the video processor 106 may determine that the previous frame corresponding to the time instant T′9 has changed from B to C, that the current frame corresponding to the time instant T′9 has changed from C to D, that the current output-frame count corresponding to the time instant T′8 minus 1 equals 0, and that the input frame D is the first input frame received after the delay. As a result, the video processor 106 may set the current input-frame count corresponding to the time instant T′9 to be the current input-frame count corresponding to the time instant T′8 (i.e., 2) minus 1, plus a compensation value (e.g., 1) and an irregular/non-ideal output frame number (e.g., 1). Consequently, the current input-frame count corresponding to the time instant T′9 equals 3 (i.e., 2−1+1+1). Furthermore, the video processor 106 may determine that one inserted frame is output at the time instant T′8, that the current output-frame count corresponding to the time instant T′8 minus 1 equals 0, and that the input frame D is the first input frame received after the delay. As a result, the video processor 106 may set the current output-frame count corresponding to the time instant T′9 to be the current output-frame count corresponding to the time instant T′8 (i.e., 1) minus 1, plus a compensation value (e.g., 2) and an irregular/non-ideal output frame number (e.g., 4). Consequently, the current output-frame count corresponding to the time instant T′9 equals 6 (i.e., 1−1+2+4). An irregular/non-ideal output frame number may reflect the time difference between input frames (or the corresponding number of inserted frames) when an irregular/non-ideal input condition occurs. For example, the time difference between the input frame C received at the time instant T′5 and the input frame D received at the time instant T′9 corresponds to the output of four inserted frames, rather than output of two inserted frames expected under the ideal/regular pattern. Accordingly, the video processor 106 may set the irregular/non-ideal output frame number to 4 and the irregular/non-ideal input frame number to 1. As set forth above, the phase step corresponding to a time instant may be at least a function of the current input-frame count, the current output-frame count, the irregular/non-ideal output frame number (i.e., the number of irregular/non-ideal output frame(s)), the irregular/non-ideal input frame number (i.e., the number of irregular/non-ideal input frame(s)), the phase corresponding to that time instant, the time difference between the reception time instants of the previous frame and the current frame, or the number of inserted frames corresponding to that time difference, the ratio between the input frame rate and the output frame rate, or whether an irregular/non-ideal input condition occurs between the previous frame and the current frame. Furthermore, Equation (1) may be defined as

$$PhStep = \frac{InCount - Ph}{OutCount} ,$$

where PhStep, Ph, InCount, and OutCount represent the phase step, the phase, current input-frame count, and the current output-frame count, respectively.

Corresponding to time instants T′11 to T′14 in FIG. 2, the video processor 106 receives two input frames E and F and outputs four output frames in conformance with the ideal/regular pattern. The video processor 106 may combine a previous frame D and a current frame E, combine a previous frame E and a current frame F, and generate inserted frames corresponding to the time instants T′11, T′12, T′13, and T′14 using interpolation or extrapolation. The video processor 106 may, in Step S202, set the phases corresponding to the time instants T′11 and T′13 to be the phases corresponding to the time instants T′10 and T′12 plus the phase steps corresponding to the time instants T′10 and T′12 minus 1, and set the phases corresponding to the time instants T′12 and T′14 to be the phases corresponding to the time instants T′11 and T′13 plus the phase steps corresponding to the time instants T′11 and T′13. Accordingly, the phases corresponding to the time instants T′11 to T′14 are ⅔ (i.e., 4/3+⅓−1), 3/3 (i.e., ⅔+⅓), ⅓ (i.e., 3/3+⅓−1), and ⅔ (i.e., ⅓+⅓), respectively. As set forth above, after the phase step is adjusted to ⅓ at the time instant T′9, phases gradually converge.

Please note that the video processor 106 may continuously apply the adjusted phase step over subsequent time instants (e.g., T′10 to T′14). For example, after receiving the input frame D and adjusting the input update value corresponding to the time instant T′9 to 1, the video processor 106 may determine that, before the time instant T′9, four inserted frames were output while only one input frame C was received, which deviates from the ideal/regular pattern. Therefore, the video processor 106 may adjust the phase step from ½ to ⅓ at the time instant T′9. Until the current input-frame count and the current output-frame count both return to 0—provided that no other irregular/non-ideal input condition occurs during this period—the video processor 106 may maintain the phase step at the adjusted phase step of ⅓, and skip the phase step adjustment in Step S203.

Corresponding to time instants T′15 and T′16 in FIG. 2, the video processor 106 receives one input frame G and outputs two output frames in conformance with the ideal/regular pattern. The video processor 106 may combine a previous frame F and a current frame G, and generate inserted frames corresponding to the time instants T′15 and T′16 using interpolation. For the time instant T′15, since the video processor 106 receives one input frame G, the video processor 106 may, in Step S202, set the phase corresponding to the time instant T′15 (i.e., ⅔+⅓−1=0) to be the phase corresponding to the time instant T′14 plus the phase step corresponding to the time instant T′14, minus 1. Furthermore, for the time instant T′15, the video processor 106 may determine that one input-output cycle restarts at the time instant T′15, based on the fact that the current input-frame count and the current output-frame count corresponding to the time instant T′14 both decrease by 1 to 0, or based on the fact that the phase corresponding to the time instant T′15 equals 0. Accordingly, the video processor 106 may reset the current input-frame count and the current output-frame count corresponding to the time instant T′15 to their initial values of 1 and 2, respectively, and may re-adjust the phase step in Step S203, for example, by reverting the phase step back to the initial value of ½ or by calculating the phase step as ½ according to Equation (1). As set forth above, the phases and phase steps corresponding to the time instants T′15 and T′16 resume regularity, exhibiting the same phases and phase steps as those corresponding to the time instants T′1 to T′6.

As illustrated by virtual effects or virtual positions in FIG. 2, the video processor 106 may calculate an appropriate phase for any given time instant, thereby enabling the generation of inserted frames with smooth visual effects from the previous frame and the current frame through interpolation or extrapolation.

Please note that a virtual position may not be a specific position located within a frame, but rather serves as a parameter about the position in an algorithm. Such a virtual position may be simulated using a virtual moving object. Therefore, while the position of a real object (e.g., an image of a soccer ball) may be described using X and Y coordinates, the virtual position of a virtual object may be described using a numerical value. Similarly, a virtual effect may not represent the actual result of an inserted frame. Instead, it indicates that the resulting image of the inserted frame may appear similar to the virtual effect.

Please note that the current input-frame count and the current output-frame count involve convergence of phases and phase steps. In one embodiment, the current input-frame count may be regarded as a quota, the current output-frame count may be regarded as the number of time units to be consumed, and the phase may be regarded as an initial phase. For example, under the ideal/regular pattern (e.g., at the time instants T′1 to T′2), one input frame is consumed using two output frames. Thus, after two output frames are output (e.g., at the time instant T′3), an input-output cycle may restart, allowing the phase step to revert to ½ and phases to revert to the ideal/regular pattern of 0, ½, 0, ½. As another example, the current input-frame count and the current output-frame count corresponding to the time instant T′9 are 3 and 6, respectively, which may be regarded as using six output frames to consume three input frames. Moreover, the initial phase corresponding to the time instant T′9 equals 2/2. Accordingly, each output frame consumes ⅓, and input-output balance is achieved over these six output frames. Furthermore, both the current input-frame count and the current output-frame count corresponding to the time instant T′15 decrease to 0—that is, although the phases of these six output frames may not follow a regular/periodic pattern, once they are output (e.g., at time instant T′15), the phase step may revert to ½ and phases may revert to the ideal/regular pattern of 0, ½, 0, ½. From another perspective, after an irregular/non-ideal input condition occurs (e.g., at the time instant T′7), the video processor 106 begins (e.g., at the time instant T′9) to diffuse the effect caused by the irregular/non-ideal input condition by using several subsequent inserted frames. Here, the current output-frame count may be regarded as the number of inserted frames consumed/required to disperse the irregular/non-ideal input condition. For example, the current output-frame count corresponding to the time instant T′9 equals 6, and the video processor 106 outputs six inserted frames with irregular phases from the time instant T′9 to the time instant T′14. Because of the calculation of the phase step, each of these six phases corresponding to the time instants T′10 to T′15 is a function of the current output-frame count corresponding to the time instant T′9. After the time instant T′15, the phase step may revert to ½, and phases may revert to 0, ½, 0, ½ in the regular/periodic pattern.

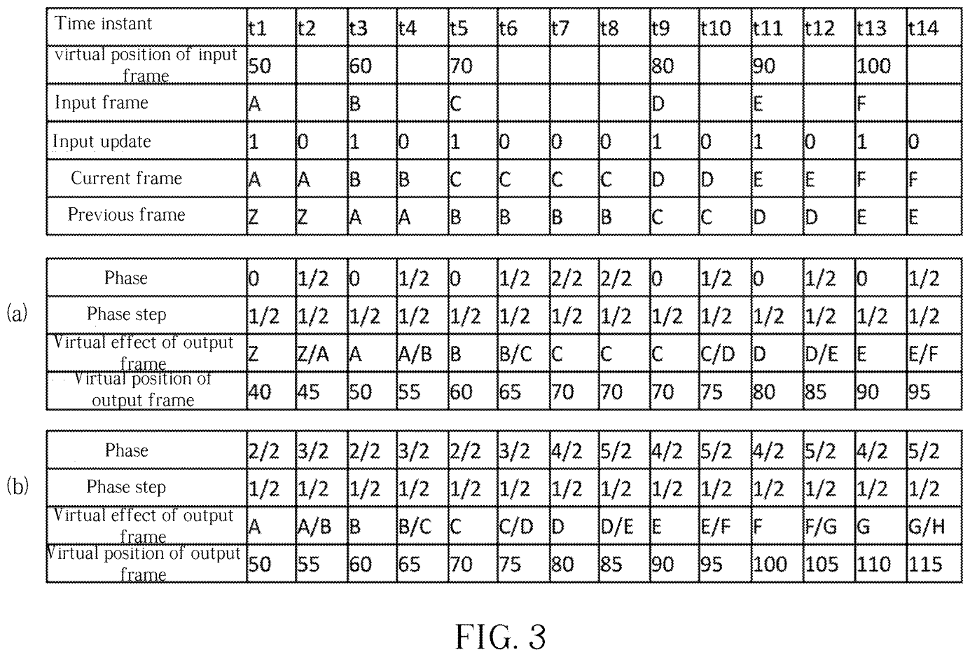

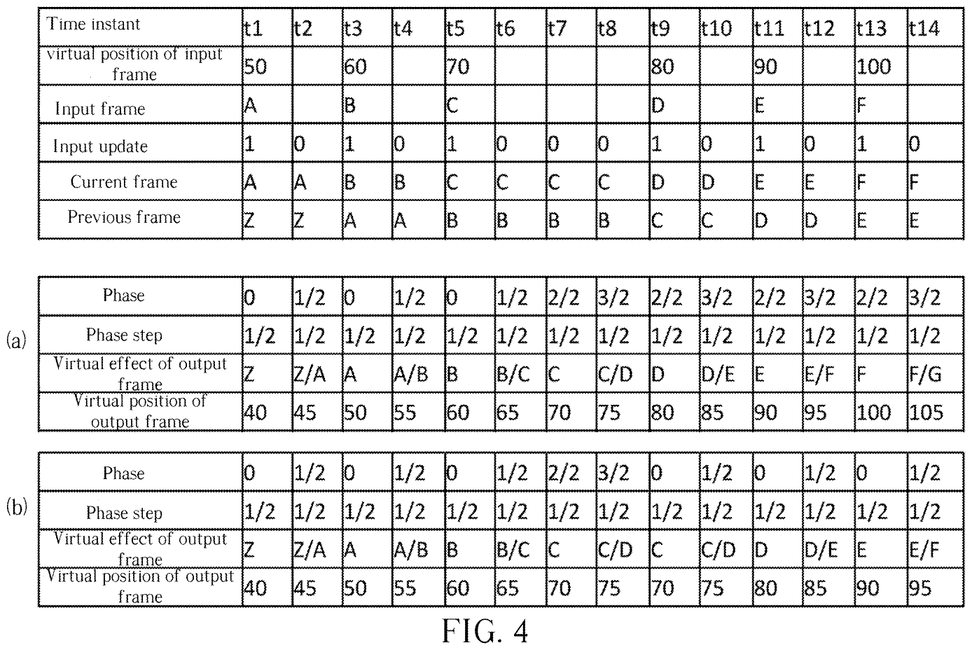

FIG. 3 and FIG. 4 illustrate frame rate conversion of converting a source video of 60 Hz into 120 Hz for display according to an embodiment of the present disclosure.

FIG. 3(a) employs pure interpolation. If an input frame rate is lower than a predetermined input frame rate or an input frame is delayed, a new input frame (e.g., D) fails to be received in time at an expected time instant (e.g., t7). Consequently, the video processor 106 is unable to generate continuous phase(s) based on the original interpolation rules, and may only repeatedly output the current frame (e.g., C) until a new input frame arrives. As indicated by the virtual positions, this results in image stuttering and unsmooth playback.

FIG. 3(b) employs pure extrapolation. If a new input frame (e.g., D) fails to be timely received at the expected time instant (e.g., t7), extrapolation may be used to generate continuous phase(s) (e.g., 4/2 and 5/2). However, if left unadjusted, phase(s) may remain at large value(s) (i.e., 4/2 and 5/2), degrading output image quality. Furthermore, extrapolation may cause the virtual position(s) of output frame(s) to advance ahead of the virtual position(s) of the corresponding input frame(s), potentially leading to significant deviations from the expected virtual position(s) to be output.

FIG. 4(a) adopts a combination of interpolation and extrapolation. If a new input frame (e.g., D) fails to be received in time at the expected time instant (e.g., t7), applying extrapolation without subsequent adjustment to phase(s) may lead to poor output image quality, like pure extrapolation.

FIG. 4(b) adopts a combination of interpolation and extrapolation. If a new input frame (e.g., D) fails to be received in time at the expected time instant (e.g., t7), forcibly resetting phase(s) back to interpolation may cause a rebound (or jump-back) phenomenon of inserted frame(s), resulting in display jitter.

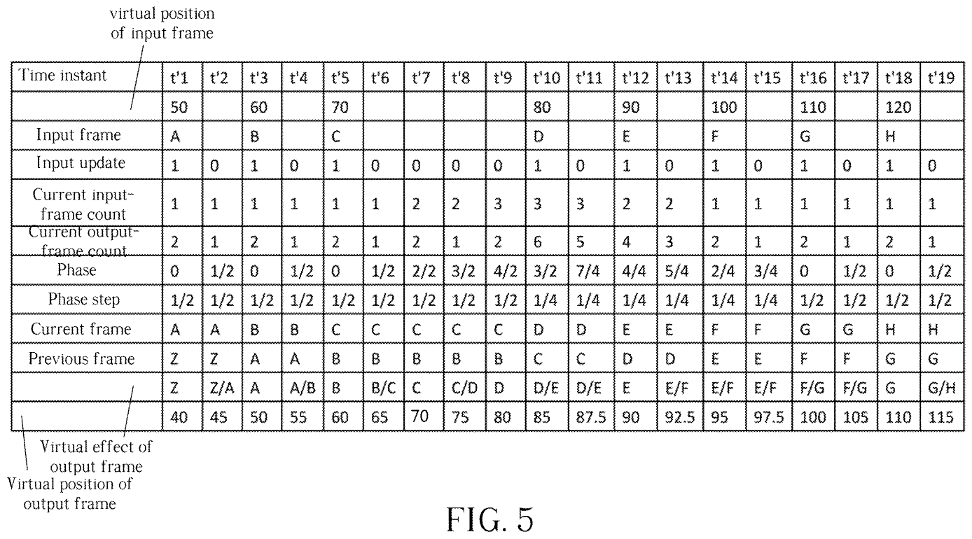

FIG. 5 illustrates frame rate conversion of converting a source video of 60 Hz into 120 Hz for display according to an embodiment of the present disclosure.

Unlike FIG. 2, where the input frame D is received after four inserted frames have been inserted following the input frame C, the video processor 106 in FIG. 5 does not receive the input frame D until the time instant t′10. Therefore, the time difference (or the corresponding number of inserted frames) between the input frames C and D equals 5. Given that the phase, the current input-frame count, and the current output-frame count corresponding to the time instant t′10 are 3/2, 3, and 6, respectively, the video processor 106 may, in Step S203, adjust the phase step corresponding to the time instant t′10 to 3/12

$$( i . e . , \frac{3 - \frac{3}{2}}{6} )$$

based on Equation (1). Consequently, the phase step corresponding to the time instant t0 differs from or is less than the phase step corresponding to the time instant t′9 (i.e., ½).

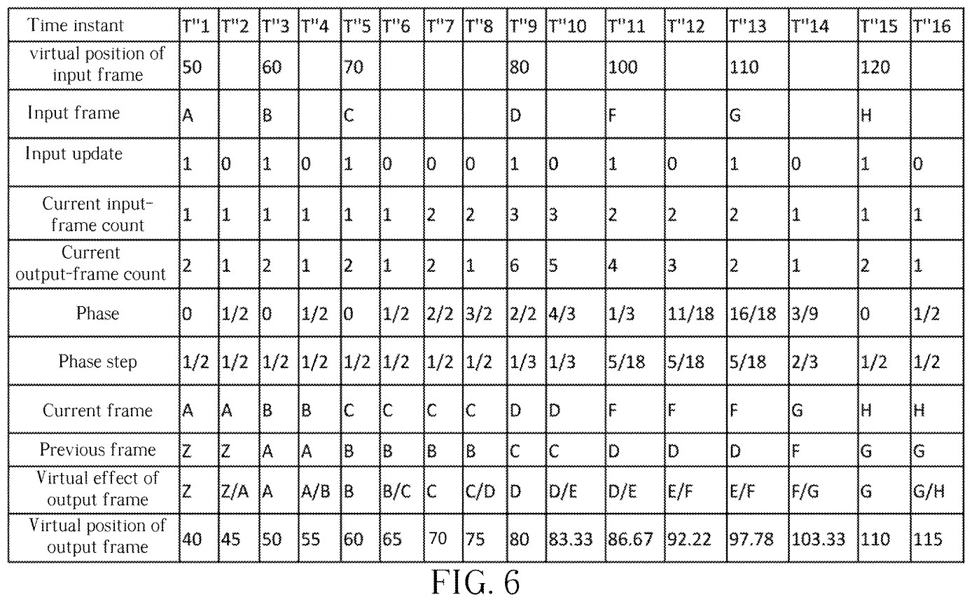

FIG. 6 illustrates frame rate conversion of converting a source video of 60 Hz into 120 Hz for display according to an embodiment of the present disclosure. Operations at time instants T″1 to T″10 in FIG. 6 are similar to the operations at the time instants T′1 to T′10 in FIG. 2, which are not reiterated herein.

Corresponding to the time instant T″11 in FIG. 6, the video processor 106 receives the input frame F, instead of the next scheduled frame (i.e., E) corresponding to the previous frame D. Therefore, an irregular/non-ideal input condition (i.e., a frame drop or an input frame movement offset) occurs. Insufficient graphics processing unit (GPU) performance may cause rendering delays. Consequently, certain image frames (e.g., the next scheduled frame or the expected frame E) may be skipped if not rendered in time, resulting in an image offset in input frame(s) supplied to the video processor 106.

In such a case, the video processor 106 may combine a previous frame D and a current frame F based at least on a phase, and generate inserted frames corresponding to the time instants T″11 and T″12 using interpolation. For the time instant T″11, since the video processor 106 receives one input frame F, but the image displacement between the input frames D and F differs from the image displacement between the previously received input frames C and D, the phase corresponding to the time instant T″11 is calculated differently from that corresponding to the time instant T″9. To generate smooth output frame(s), the video processor 106 may calculate the phase corresponding to the time instant T″11 using a scaling value. For example, since the image displacement between the input frames D and F is determined to be twice the image displacement between the input frames C and D, the video processor 106 may, in Step S202, calculate the phase corresponding to the time instant T″11 by adding the phase corresponding to the time instant T″10 and the phase step corresponding to the time instant T″10, subtracting 1, and multiplying the result by the scaling value corresponding to the time instant T″11 (e.g., ½). Accordingly, the phase corresponding to the time instant T″11 is ⅓ (i.e., (4/3+⅓−1)×½). Because of the frame drop occurring at the time instant T″11, after calculating the phase corresponding to the time instant T″11 in Step S202, the video processor 106 may adjust the phase step corresponding to the time instant T″11 in Step S203. Accordingly, phases after the time instant T″11 gradually converge. For the time instant T″12, since no input frames are received, the video processor 106 may, in Step S202, set the phase corresponding to the time instant T″12 (i.e., ⅓+5/18=11/18) to be the phase corresponding to the time instant T″11 plus the phase step corresponding to the time instant T″11 (e.g., adjusted to 5/18).

The phase step may be adjusted in various ways. For example, given that the phase, the current input-frame count, the current output-frame count, and the displacement adjustment value corresponding to the time instant T″11 are ⅓, 2, 4, and 2, respectively, the video processor 106 may, in Step S203, adjust the phase step corresponding to the time instant T″11 to 5/18

$$( i . e . , \frac{2 - \frac{1}{3}}{4 + 2} )$$

according to Equation (2). Consequently, the adjusted phase step differs from or is less than the phase step corresponding to the time instant T″10 (i.e., ⅓). Specifically, because the previous frame corresponding to the time instant T″11 is determined to be changed from C to D and the current frame corresponding to the time instant T″11 is determined to be changed from D to F, the video processor 106 may set the current input-frame count corresponding to the time instant T″11 (i.e., 3−1=2) by subtracting 1 from the current input-frame count corresponding to the time instant T″10 (i.e., 3). Furthermore, since one inserted frame is determined to be output at the time instant T″10, the video processor 106 may set the current output-frame count corresponding to the time instant T″11 (i.e., 5−1=4) to be the current output-frame count corresponding to the time instant T″10 (i.e., 5) minus 1. The displacement adjustment value may reflect the displacement change between the previous frame D and the current frame F. For example, if the image displacement between the previous frame D and the current frame F (e.g., a virtual position of the previous frame D and a virtual position of the current frame F differ by 20) is twice the image displacement under the ideal/regular pattern (e.g., 10), up to two additional inserted frames must be calculated to maintain image continuity, given that the ratio between the input frame rate and the output frame rate is 1:2. Therefore, the video processor 106 may set the displacement adjustment value corresponding to the time instant T″11 to 2. Alternatively, from another perspective, since the current frame F is, by default, the second frame after the previous frame D, up to two additional inserted frames must be calculated. Accordingly, the video processor 106 may set the displacement adjustment value corresponding to the time instant T″11 to 2. As set forth above, the phase step corresponding to a time instant may be a function of at least the current input-frame count, the current output-frame count, the displacement adjustment value, the phase corresponding to that time instant, the default sequential order of the current frame relative to the previous frame, the ratio between the input frame rate and the output frame rate, or whether an irregular/non-ideal input condition has occurred between the previous frame and the current frame. Equation (2) may be defined as

$$PhStep = \frac{InCount - Ph}{OutCount + DisplAdjust} ,$$

where PhStep, Ph, InCount, OutCount, and DisplAdjust represent the phase step, the phase, the current input-frame count, the current output-frame count, and the displacement adjustment value, respectively.

Corresponding to the time instants T″13 and T″14 in FIG. 6, the video processor 106 receives one input frame G and outputs two output frames in conformance with the ideal/regular pattern. However, since the sum of the phase and the phase step corresponding to the time instant T″12 is less than 1, the video processor 106 still uses the input frames D and F for the time instant T″13 without replacing the frame set comprising the previous frame and the current frame. Therefore, the video processor 106 may combine a previous frame D and a current frame F, and generate an inserted frame corresponding to the time instant T″13 using interpolation. For the time instant T″13, since the video processor 106 receives but does not immediately adopt the input frame G, the video processor 106 may maintain the current input-frame count corresponding to the time instant T″13 equal to the current input-frame count corresponding to the time instant T″12 (i.e., 2). Furthermore, the video processor 106 may, in Step S202, calculate the phase corresponding to the time instant T″13 by adding the phase corresponding to the time instant T″12 and the phase step corresponding to the time instant T″12 without subtracting 1. Consequently, the phase corresponding to the time instant T″13 is 16/18 (i.e., 11/18+5/18), which remains greater than 0.

Corresponding to the time instant T″14, the video processor 106 may replace the frame set constituted by the previous frame and the current frame, combine a previous frame F and a current frame G based at least on a phase, and generate an inserted frame corresponding to the time instant T″14 using interpolation. For the time instant T″14, no input frame is received and the image displacement between the input frames F and G differs from that between the input frames D and F previously used. Therefore, to generate smooth output frame(s), the video processor 106 may calculate the phase corresponding to the time instant T″14 based on a scaling value. For example, since the image displacement between the input frames F and G is determined to be half of that between the input frames D and F, the video processor 106 may, in Step S202, calculate the phase corresponding to the time instant T″14 by adding the phase corresponding to the time instant T″13 and the phase step corresponding to the time instant T″13, subtracting 1, and multiplying the result by the scaling value corresponding to the time instant T″14 (e.g., 2). Accordingly, the phase corresponding to the time instant T″14 is ⅓ (i.e., (16/18+5/18−1)×2). Because the time instant T″14 corresponds to recovery from a frame drop back to a non-frame-drop state, after calculating the phase corresponding to the time instant T″14 in Step S202, the video processor 106 may adjust the phase step corresponding to the time instant T″14 in Step S203, allowing phases to gradually converge after the time instant T″14.

The phase step may be adjusted in various ways. For example, given that the phase, the current input-frame count, the current output-frame count, and the displacement adjustment value corresponding to the time instant T″14 are ⅓, 1, 1, and 0, respectively, the video processor 106 may, in Step S203, adjust the phase step corresponding to the time instant T″14 to ⅔

$$( i . e . , \frac{1 - \frac{1}{3}}{1 + 0} )$$

according to Equation (2). Consequently, the adjusted phase step differs from or is greater than the phase step corresponding to the time instant T″13 (i.e., 5/18). Specifically, since the previous frame corresponding to the time instant T″14 is determined to be changed from D to F, and the current frame corresponding to the time instant T″14 is determined to be changed from F to G, the video processor 106 may set the current input-frame count corresponding to the time instant T″14 (i.e., 2−1=1) to be the current input-frame count corresponding to the time instant T″13 (i.e., 2) minus 1. Furthermore, because one inserted frame is determined to be output at the time instant T″13, the video processor 106 may set the current output-frame count corresponding to the time instant T″14 (i.e., 2−1=1) to be the current output-frame count corresponding to the time instant T″13 (i.e., 2) minus 1. The displacement adjustment value may reflect the displacement change between the previous frame F and the current frame G. For example, if the image displacement between the previous frame F and the current frame G (e.g., the difference between a virtual position of the previous frame F and a virtual position of the current frame G is 10) equals the image displacement under the ideal/regular pattern (e.g., 10), no additional inserted frame needs to be calculated. Accordingly, the video processor 106 may set the displacement adjustment value corresponding to the time instant T″14 to 0. Alternatively, from another perspective, since the current frame G is, by default, the first frame after the previous frame F, no additional inserted frame needs to be calculated. Therefore, the video processor 106 may set the displacement adjustment value corresponding to the time instant T″14 to 0. Since the displacement adjustment value is 0, it may be omitted when calculating the phase step. In other words, omitting the displacement adjustment value is equivalent to setting it to 0.

Corresponding to the time instants T″15 and T″16 in FIG. 6, the video processor 106 receives one input frame H and outputs two output frames in conformance with the ideal/regular pattern. The video processor 106 may combine a previous frame G and a current frame H based at least on a phase, and generate inserted frames corresponding to the time instants T″15 and T″16 using interpolation. In general, operations at the time instants T′15 and T′16 in FIG. 2 are similar to those at the time instants T″15 and T″16 in FIG. 6. In other words, the video processor 106 may determine that an input-output cycle restarts at the time instant T″15, and may re-adjust the phase step for example, by reverting the phase step to the initial value of ½ or by calculating it as ½ according to Equation (1) or 2 so that subsequent phases return to regularity.

Please note that if no irregular/non-ideal input condition occurs, the video processor 106 may continuously apply the same phase step over several time instants. For example, after determining that outputting four inserted frames while receiving only one input frame C before the time instant T″9 deviates from the ideal/regular pattern, the video processor 106 may adjust the phase step from ½ to ⅓ in Step S203, and maintain the adjusted phase step (i.e., ⅓) at the subsequent time instant T″10. Alternatively, after determining that the frame received at the time instant T″11 is not the next scheduled frame E corresponding to the previous frame D, which deviates from the ideal/regular pattern, the video processor 106 may adjust the phase step from ⅓ to 5/18 in Step S203, and maintain the adjusted phase step (i.e., 5/18) at the subsequent time instants T″12 and T″13. Alternatively, after determining that the previous frame F and the current frame G adopted at the time instant T″14 conform to the ideal/regular pattern, the video processor 106 may adjust the phase step from 5/18 to ⅔ in Step S203. Alternatively, after determining that an input-output cycle restarts at the time instant T″15, the video processor 106 may adjust the phase step from 2/3 back to ½ in Step S203. As shown above, the video processor 106 may adjust the phase step after an irregular/non-ideal input condition or when the input condition returns to the ideal/regular pattern, allowing phases to gradually converge toward the ideal/regular pattern of 0, ½, 0, ½. In other words, appropriately adjusting a phase step helps ensure the regularity of phases and phase steps in the long run.

FIG. 7 illustrates frame rate conversion of converting a source video of 60 Hz into 120 Hz for display according to an embodiment of the present disclosure. Operations at time instants T′″1 to T′″11 in FIG. 7 are similar to those at the time instants t′1 to t′11 in FIG. 5, which are not reiterated herein.

Corresponding to the time instant T′″12 in FIG. 7, the video processor 106 receives the input frame F instead of the next scheduled frame (i.e., E) corresponding to the previous frame D, and the video processor 106 does not receive any input frame at the time instant T′″14. The video processor 106 may combine a previous frame D and a current frame F based at least on a phase, and generate inserted frames corresponding to the time instants T′″12 to T′″14 using interpolation or extrapolation. For the time instant T′″12, the video processor 106 receives one input frame F, but the image displacement between the input frames D and F is twice that between the input frames C and D. Consequently, the video processor 106 may, in Step S202, calculate the phase corresponding to the time instant T′″12 (i.e., (7/4+¼−1)×½=2/4) by adding the phase corresponding to the time instant T′″11 and the phase step corresponding to the time instant T′″11, subtracting 1, and multiplying the result by a scaling value corresponding to the time instant T′″12 (e.g., ½). Furthermore, given that the phase, the current input-frame count, the current output-frame count, and the displacement adjustment value corresponding to the time instant T′″12 are ½, 2, 4, and 2, respectively, the video processor 106 may, in Step S203, use Equation (2) to adjust the phase step corresponding to the time instant T′″12 to ¼

$$( i . e . , \frac{2 - \frac{1}{2}}{4 + 2} ) ,$$

which matches the phase step corresponding to the time instant T′10

$$( i . e . , \frac{3 - \frac{3}{2}}{6} = 1 / 4 ) .$$

Corresponding to the time instant T′″15 in FIG. 7, the video processor 106 receives the input frame H instead of the next scheduled frame (i.e., G) corresponding to the previous frame F. The video processor 106 may combine a previous frame F and a current frame H based at least on a phase. Correspondingly, the video processor 106 may select interpolation from interpolation and extrapolation, and generate inserted frames corresponding to the time instants T′″15 and T′″16 using interpolation. For the time instant T′ 15, the video processor 106 receives the input frame H instead of the next scheduled frame G. However, the image displacement between the input frames F and H is the same as that between the input frames D and F (i.e., the same scaling factor for input frame movement offsets), and both the image displacements are twice the image displacement under the ideal/regular pattern (e.g., 10). The scaling value may thus be omitted when calculating the phase; equivalently, the scaling value may be regarded as being set to 1. The video processor 106 may, in Step S202, set the phase corresponding to the time instant T′″15 (i.e., 4/4+¼−1=¼) to be the phase corresponding to the time instant T′″14 plus the phase step corresponding to the time instant T′″14 minus 1.

The phase step may be adjusted in various ways. For example, given that the phase, the current input-frame count, the current output-frame count, and the displacement adjustment value corresponding to the time instant T′″15 are ¼, 2, 4, and 2, respectively, the video processor 106 may, in Step S203, adjust the phase step corresponding to the time instant T′″15 to 7/24

$$( i . e . , \frac{2 - \frac{1}{4}}{4 + 2} )$$

according to Equation (2). Consequently, the adjusted phase step differs from or is less than the phase step corresponding to the time instant T′″14 (i.e., ¼). Specifically, the video processor 106 may determine that the previous frame corresponding to the time instant T′″15 is changed from D to F, and that the current frame corresponding to the time instant T′″15 is changed from F to the input frame H, which is determined to be the first input frame received after the delay. Consequently, the video processor 106 may set the current input-frame count corresponding to the time instant T′15 (i.e., (2−1)+1=2) to be the current input-frame count corresponding to the time instant T′″14 (i.e., 2) minus 1, and plus the irregular/non-ideal input frame number (e.g., 1). Furthermore, since one inserted frame is determined to be output at the time instant T′″14 and the input frame H is determined to be the first input frame received after the delay, the video processor 106 may calculate the current output-frame count corresponding to the time instant T′″15 (i.e., (2−1)+3=4) by subtracting 1 from the current output-frame count corresponding to the time instant T′″14 (i.e., 2) and adding the irregular/non-ideal output frame number (e.g., 3). Since the input frame H is determined to be received after three inserted frames have been inserted following the input frame F, the video processor 106 may set the irregular/non-ideal input frame number to 1 and the irregular/non-ideal output frame number to 3. Since the image displacement between the previous frame F and the current frame H (e.g., a virtual position of the previous frame F and a virtual position of the current frame H differ by 20) is determined to be twice the image displacement under the ideal/regular pattern (e.g., 10), up to two additional inserted frames must be calculated to maintain image continuity, for the ratio of 1:2 between the input frame rate and the output frame rate. Accordingly, the video processor 106 may set the displacement adjustment value corresponding to the time instant T′″15 to 2.

Note that the video processor 106 may continue using the existing phase step without adjustment if no frame drop occurs (or if the state is not recovering from a frame drop to a non-frame-drop state). Conversely, the video processor 106 may adjust the phase step upon a frame drop (during recovery from a frame drop to a non-frame-drop state). The calculation of the phase step depends on: a displacement adjustment value, the multiple of the image displacement between the previous frame and the current frame relative to the image displacement under the ideal/regular pattern, or the default sequential order in which the current frame is scheduled after the previous frame. On the other hand, the video processor 106 calculates the phase for each inserted frame to be output. The phase may depend on: a scaling value, the multiple of the image displacement between the previous frame and the current frame relative to the image displacement between the frame before the previous frame and the previous frame, the default sequential order in which the current frame is scheduled after the previous frame, or the default sequential order in which the previous frame is scheduled after the frame before the previous frame.

Corresponding to the time instants T′″17 and T′″18 in FIG. 7, the video processor 106 receives one input frame I and outputs two output frames in conformance with the ideal/regular pattern. Since the sum of the phase and the phase step corresponding to the time instant T′″16 is determined to be less than 1, the video processor 106 still uses the input frames F and H for the time instant T′″17 without replacing the frame set comprising the previous frame and the current frame. Therefore, the video processor 106 may combine a previous frame F and a current frame H based at least on a phase, and generate an inserted frame corresponding to the time instant T′″17 using interpolation. The calculation of the phase corresponding to the time instant T′″17 in FIG. 7 is substantially the same as that of the phase corresponding to the time instant T″13 in FIG. 7. Accordingly, the video processor 106 may set the phase corresponding to the time instant T′″17 (i.e., 13/24+7/24=20/24) to be the phase corresponding to the time instant T′″16 plus the phase step corresponding to the time instant T′″16.

Corresponding to the time instant T′″18, the video processor 106 may replace the frame set comprising the previous frame and the current frame. Moreover, the video processor 106 may combine a previous frame H and a current frame I based at least on a phase, and generate an inserted frame corresponding to the time instant T′″18 using interpolation. For the time instant T′″18, because the video processor 106 does not receive any input frame and the image displacement between the input frames H and I is determined to be one half of the image displacement between the input frames F and H previously used, the video processor 106 may, in Step S202, calculate the phase corresponding to the time instant T′″18 (i.e., (20/24+7/24−1)×2=6/24) by adding the phase corresponding to the time instant T′″17 and the phase step corresponding to the time instant T′″17, subtracting 1, and multiplying the result by the scaling value corresponding to the time instant T′″18 (e.g., 2). Since the image displacement between the previous frame H and the current frame I (e.g., the difference between a virtual position of the previous frame H and a virtual position of the current frame I equals 10) is determined to be equal to the image displacement under the ideal/regular pattern (e.g., 10), the video processor 106 may, in Step S203, adjust the phase step corresponding to the time instant T′″18 to ¾

$$( i . e . , \frac{1 - \frac{6}{24}}{1 + 0} )$$

according to Equation (2), given that the phase, the current input-frame count, the current output-frame count, and the displacement adjustment value corresponding to the time instant T′″18 are 6/24, 1, 1, and 0, respectively. Accordingly, the adjusted phase step differs from or is greater than the phase step corresponding to the time instant T′″17 (i.e., 7/24), thereby causing phases to gradually converge after the time instant T′″18.

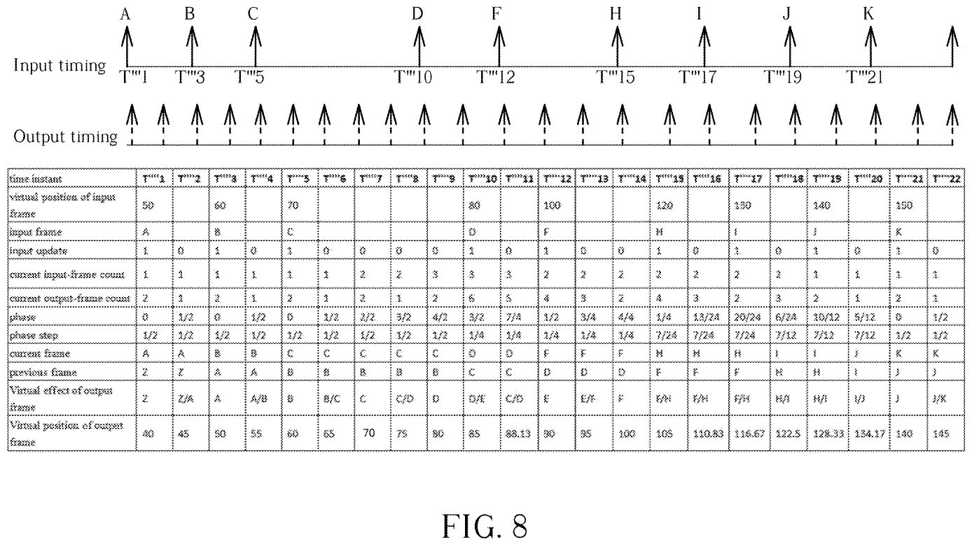

FIG. 8 illustrates frame rate conversion of converting a source video of 60 Hz into 120 Hz for display according to an embodiment of the present disclosure. Operations at time instants T″″1 to T″″17 in FIG. 8 are similar to those at the time instants T′″l to T′″17 in FIG. 7, which are not reiterated herein.

To achieve a more gradual change in the phase step, the current input-frame count and the current output-frame count may be functions of compensation values (e.g., 1 and 2), and the ratio between the compensation values may correspond to the ratio between the input frame rate and the output frame rate (e.g., 1:2). For example, because the previous frame corresponding to the time instant T″″18 is determined to be changed from F to H, and the current frame corresponding to the time instant T″″18 is determined to be changed from H to I, the video processor 106 may set the current input-frame count corresponding to the time instant T″″18 (i.e., 2−1+1=2) to be the current input-frame count corresponding to the time instant T″″17 (i.e., 2) minus 1, plus a compensation value (e.g., 1). Furthermore, because one inserted frame is determined to be output at the time instant T″″17, the video processor 106 may set the current output-frame count corresponding to the time instant T″″18 (i.e., 2−1+2=3) to be the current output-frame count corresponding to the time instant T″″17 (i.e., 2) minus 1, plus a compensation value (e.g., 2). Given that the phase, the current input-frame count, the current output-frame count, and the displacement adjustment value corresponding to the time instant T″″18 are 6/24, 2, 3, and 0, respectively, the video processor 106 may, in Step S203, adjust the phase step corresponding to the time instant T″″18 to 7/12

$$( i . e . , \frac{2 - \frac{6}{24}}{3 + 0} )$$

according to Equation (2). This extends the duration over which the adjusted phase step takes effect, thereby producing smoother inserted frames.

Please note that an entire inserted frame (e.g., all its image blocks) corresponds to one single phase, while the motion vector between an image block of the current frame and the corresponding image block of the previous frame may differ from the motion vector between another image block of the current frame and the corresponding image block of the previous frame. In other words, the calculated phase enables the positioning of any image block within an inserted frame—even though motion vectors relative to the previous frame may vary across different image blocks within the current frame—thereby enhancing output smoothness.

In one embodiment, in FIG. 2 to FIG. 8, the time difference between any two adjacent time instants (e.g., T″″1 and T″″2) is substantially equal to (or close to) either the reciprocal (e.g., 1/120 second) of the output frame rate (e.g., 120 Hz) of the output frames or half the reciprocal (e.g., 1/60 second) of the predetermined input frame rate (e.g., 60 Hz) of the input frames. However, due to potential errors, this time difference may not exactly equal the reciprocal of the output frame rate. Furthermore, the time difference between a pair of two adjacent time instants may differ from the time difference between another pair of adjacent time instants.

In one embodiment, a delay can be detected by calculating the time difference between the reception of two consecutive input frames. For example, if the time difference (e.g., between the time instants T″″5 and T″″10) is greater than or equal to a time difference threshold, it is determined that a delay occurs. The time difference threshold may be substantially equal to or greater than the reciprocal of the predetermined input frame rate. Conversely, the time difference (e.g., between the time instants T″″1 and T″″3) below the time difference threshold indicates that the input frames and the output frames form a stable sequence conforming to the predetermined relationship between the input frame rate and the output frame rate.

In one embodiment, a frame drop can be detected using information signal(s) corresponding to input frame(s). For example, if the information signals of front-end input frames are sequentially 1, 2, 3, 4, 5, 6, . . . , but input frames received by the video processor 106 correspond to 1, 2, 4, 5, 6, . . . , the video processor 106 determines that the image displacement between the first two input frames equals the image displacement among the last three input frames. However, the video processor 106 also determines that the image displacement between the second and the third input frames is twice the aforementioned uniform image displacement, indicating that an input frame movement offset occurs.

In one embodiment, the information signal may be a time stamp or an index number (e.g., F). An image frame may correspond to, be added with, specify, or carry a time stamp. A time stamp is used to indicate the chronological order of image contents of image frames, where in the source video the image frame should be located, or the scheduled start or end time instant for processing of the image frame. Furthermore, a time stamp may be used to determine whether an input frame received at certain time instant is the one expected at that time instant (i.e., the next scheduled frame). For example, based on a time stamp (e.g., 86474321794) of an input frame received at a time instant (e.g., T″″12), the frame rate converter 104 may identify the input frame as a specific image frame (e.g., F) that should be sequenced after the image frame (e.g., E) corresponding to the time stamp 86474301340 and before the image frame (e.g., G) corresponding to the time stamp 86474342875. In other words, the index number (e.g., F) or the time stamp (e.g., 86474321794) of an input frame represents the chronological order or the default sequential order of the input frame (e.g., following image frame E), which can be used to detect a frame drop.

In one embodiment, the time stamp may be generated at the video provider 12 or the video processor 106. In one embodiment, the time stamp of an image frame is associated with either a dequeue time instant at which a graphics processing unit (GPU) begins using a frame buffer 100 for an input frame, or a queue time instant at which the GPU finishes using the frame buffer 100 for that input frame. The dequeue time instant marks when the GPU begins outputting rendering results to the frame buffer 100, while the queue time instant marks when the GPU completes this output, making them available for display on the display panel 110. The time difference between the dequeue time instant and the queue time instant substantially equals the graphic rendering time performed by the GPU for that input frame. When unable to obtain the time stamp of an image frame from the video provider 12, the video processor 106 may use the dequeue (or queue) time instant to generate a time stamp for the input frame. If the time difference between two adjacent dequeue (or queue) time instants is determined to be substantially equal to (or close to) the reciprocal of the predetermined input frame rate, or if the time difference between the queue time instant and the dequeue time instant is determined to exceed a threshold, the frame rate converter 104 may determine that no frame drop has occurred.

In one embodiment, the electronic system 10 may be, for example, a mobile phone, a computer, or a television.

In one embodiment, the video provider 12 may be, for example, a digital versatile disc (DVD) player or a video streaming service provider, which may communicate with the display system 11 via a wired or wireless network.

In one embodiment, the video processor 106 may be configured to perform motion estimation and motion compensation to generate inserted frames. The video processor may be a separately provided video controller integrated circuit (IC) independent of the video provider 12; alternatively, the video processor may be implemented within a video controller integrated circuit. In one embodiment, the video processor may comprise a frame rate conversion integrated circuit; alternatively, the video processor may be a control integrated circuit with frame rate conversion functionality. That is, the frame rate converter 104 may be regarded as either an independent frame rate conversion integrated circuit or a frame rate conversion circuit located within a control integrated circuit. In another embodiment, the video processor may comprise a GPU and an independent frame rate conversion integrated circuit; alternatively, the video processor may be a GPU with a built-in frame rate conversion circuit.

In one embodiment, the video processor 106 may comprise a frame buffer 100. The frame buffer may be used to store input frame(s) received by the video processor, such that the video processor may obtain selected input frame(s) from the frame buffer to perform interpolation/extrapolation. In one embodiment, the frame buffer may be integrated with the video processor; alternatively, the video processor may access input frame(s) from independent frame buffer(s). In other words, the frame buffer may be an external memory device separate from the video processor.

In one embodiment, the frame rate converter 104 may be configured to receive an image frame (i.e., an input frame) of the source video while simultaneously receiving its previous frame stored in the frame buffer 100. The frame rate converter may generate inserted frame(s) with a frame rate conforming to the output format of the display panel 110, based on the previous frame, which is received from the frame buffer as a reference frame, and the received input frame (i.e., the current frame). The frame rate converter may be implemented using software or hardware (circuit(s)) of the display system 11 capable of performing specific functions.

In one embodiment, the display driver 108 may convert image data into data voltage signal(s), and drive the display panel 110 to display image frame(s) via the data voltage signal(s). The display driver may comprise a timing controller, a source driver, a gate driver, or any other component(s) used to drive the display panel.

In one embodiment, the display panel 110 may be of any type, such as a liquid crystal display (LCD) panel, a light-emitting diode (LED) display, and a plasma display panel (PDP), but is not limited thereto.

The use of ordinal terms such as “first” and “second” does not by itself imply any priority, precedence, the order of one element over another, the chronological sequence in which acts of a method are performed, or the necessity for all the elements to exist at the same time, but these terms are simply used as labels to distinguish one element having a certain name from another element having the same name. The technical features described in the aforementioned embodiments may be mixed or combined in various ways as long as there are no conflicts between them. The term “substantially equal” generally implies a deviation that is less than a tolerance or a minimum tolerance. As used herein, the term “or” is intended to mean the term “and/or”.

In summary, since the present disclosure enables dynamic switching between extrapolation and interpolation, the smoothness and image quality of video display can be improved.

The foregoing outlines the features of several embodiments, enabling those skilled in the art to fully appreciate the aspects of the present disclosure. Those skilled in the art should recognize that the present disclosure provides a foundation for designing or modifying other processes and structures to achieve substantially the same functions and/or substantially the same results as those of the embodiments introduced herein. Furthermore, such equivalent arrangements do not deviate from the spirit and scope of the present disclosure, and various changes, substitutions, and alterations may be made without so departing.

What is claimed is:

1. An image processing method, for a video processor, comprising:
receiving a first input frame at a first time instant; and
receiving a second input frame at a second time instant;
wherein when the second input frame is not a first next scheduled frame corresponding to the first input frame, a first inserted frame is generated using interpolation according to the first and second input frames; or
when no input frame is received at a third time instant, a second inserted frame is generated using extrapolation according to the first and second input frames, wherein a time difference between the third and second time instants is substantially greater than or equal to a time difference threshold.

2. The image processing method of claim 1, further comprising:
after determining that a first time difference is greater than the time difference threshold or that the second input frame is not the first next scheduled frame, generating a plurality of third inserted frames respectively using a plurality of first phases, which are irregular, wherein the second time instant is separated from the first time instant by the first time difference, and one of the plurality of first phases is a function of a number of the third inserted frames; and
after outputting the third inserted frames, generating a plurality of fourth inserted frames according to interpolation, respectively, using a plurality of second phases, which are regular.

3. The image processing method of claim 2, wherein a first phase step corresponding to the first phases is less than a second phase step corresponding to the second phases.

4. The image processing method of claim 1, further comprising:
after determining that a first time difference is greater than the time difference threshold or that the second input frame is not the first next scheduled frame, adjusting a phase step according to a number of output frames within the first time difference or an order index, wherein the order index indicates a default sequential order in which the second input frame is scheduled after the first input frame, wherein the second time instant is separated from the first time instant by the first time difference; and
combining the first and second input frames using the phase step to generate a fifth inserted frame.

5. The image processing method of claim 4, wherein the phase step is adjusted to become smaller.

6. The image processing method of claim 1, further comprising:
receiving a third input frame at a fourth time instant;
after determining that the second input frame is not the first next scheduled frame but the third input frame is a second next scheduled frame corresponding to the second input frame, adjusting a phase step at least according to an order index, wherein the order index indicates a default sequential order in which the second input frame is scheduled after the first input frame; and
combining the second and third input frames using the phase step to generate a sixth inserted frame.

7. The image processing method of claim 6, wherein the phase step is adjusted to become larger.

8. The image processing method of claim 1,
wherein a phase corresponding to a sixth time instant is a function of the phase step corresponding to a fifth time instant, a phase corresponding to the fifth time instant, or a scaling value corresponding to the sixth time instant;
wherein the fifth time instant is prior to the sixth time instant;
wherein a second time difference between the sixth and fifth time instants is less than the time difference threshold.

9. The image processing method of claim 1,
wherein a phase step corresponding to a sixth time instant is a function of a phase corresponding to the sixth time instant, a current input-frame count corresponding to the sixth time instant, a current output-frame count corresponding to the sixth time instant, a displacement adjustment value corresponding to the sixth time instant, a number of output frames, or a ratio between an input frame rate and an output frame rate;
wherein the time difference threshold is substantially equal to a reciprocal of a predetermined input frame rate.

10. The image processing method of claim 1,
wherein the first inserted frame is generated using interpolation based on a phase corresponding to the first inserted frame being less than 1; or
wherein the second inserted frame is generated using extrapolation based on a phase corresponding to the second inserted frame being greater than or equal to 1.

11. A video processor, comprising:
a frame rate converter, configured to receive a first input frame at a first time instant, and receive a second input frame at a second time instant; and
a frame buffer, configured to store the first or second input frame;
wherein when the second input frame is not a first next scheduled frame corresponding to the first input frame, a first inserted frame is generated using interpolation according to the first and second input frames; or
when no input frame is received at a third time instant, a second inserted frame is generated using extrapolation according to the first and second input frames, wherein a time difference between the third and second time instants is substantially greater than or equal to a time difference threshold.

12. The video processor of claim 11,
wherein after determining that a first time difference is greater than the time difference threshold or that the second input frame is not the first next scheduled frame, a plurality of third inserted frames are generated respectively using a plurality of first phases, which are irregular, wherein the second time instant is separated from the first time instant by the first time difference, and one of the plurality of first phases is a function of a number of the third inserted frames;
wherein after the plurality of third inserted frames are output, a plurality of fourth inserted frames are generated according to interpolation, respectively, using a plurality of second phases, which are regular.

13. The video processor of claim 12, wherein a first phase step corresponding to the first phases is less than a second phase step corresponding to the second phases.

14. The video processor of claim 11,
wherein after determining that a first time difference is greater than the time difference threshold or that the second input frame is not the first next scheduled frame, a phase step is adjusted according to a number of output frames within the first time difference or an order index, wherein the order index indicates a default sequential order in which the second input frame is scheduled after the first input frame, wherein the second time instant is separated from the first time instant by the first time difference;
wherein the first and second input frames are combined using the phase step to generate a fifth inserted frame.

15. The video processor of claim 14, wherein the phase step is adjusted to become smaller.

16. The video processor of claim 11,
wherein a third input frame at a fourth time instant is received;
wherein after determining that the second input frame is not the first next scheduled frame but the third input frame is a second next scheduled frame corresponding to the second input frame, a phase step is adjusted at least according to an order index, wherein the order index indicates a default sequential order in which the second input frame is scheduled after the first input frame; and
wherein the second and third input frames are combined using the phase step to generate a sixth inserted frame.

17. The video processor of claim 16, wherein the phase step is adjusted to become larger.

18. The video processor of claim 11,
wherein a phase corresponding to a sixth time instant is a function of the phase step corresponding to a fifth time instant, a phase corresponding to the fifth time instant, or a scaling value corresponding to the sixth time instant;
wherein the fifth time instant is prior to the sixth time instant;
wherein a second time difference between the sixth and fifth time instants is less than the time difference threshold.

19. The video processor of claim 11,
wherein a phase step corresponding to a sixth time instant is a function of a phase corresponding to the sixth time instant, a current input-frame count corresponding to the sixth time instant, a current output-frame count corresponding to the sixth time instant, a displacement adjustment value corresponding to the sixth time instant, a number of output frames, or a ratio between an input frame rate and an output frame rate;
wherein the time difference threshold is substantially equal to a reciprocal of a predetermined input frame rate.

20. The video processor of claim 11,
wherein the first inserted frame is generated using interpolation based on a phase corresponding to the first inserted frame being less than 1; or
wherein the second inserted frame is generated using extrapolation based on a phase corresponding to the second inserted frame being greater than or equal to 1.
